(19) United States
(12) Patent Application Publication
(10) Pub. No.: US 2025/0363806 A1
(43) Pub. Date: Nov. 27, 2025

(54) VEHICLE APPARATUS AND METHOD OF ESTIMATING LOCATION OF VEHICLE

(71) Applicants: Hyundai Motor Company, Seoul (KR); Kia Corporation, Seoul (KR)

(72) Inventors: Tae Hyun Sung, Hwaseong (KR); Hae Young Kwon, Hwaseong (KR)

(21) Appl. No.: 18/947,284

(22) Filed: Nov. 14, 2024

(30) Foreign Application Priority Data
May 23, 2024 (KR) 10-2024-0067220

(51) Int. Cl. G06V 20/56; G01C 21/30; G06T 7/73; G06V 10/25

(52) U.S. Cl. CPC G06V 20/56; G01C 21/30; G06T 7/74; G06V 10/25; G06T 2207/20132; G06T 2207/30252

(57) ABSTRACT

A vehicle apparatus includes a camera and a processor, and is configured to estimate a location of a vehicle and construct a map via image recognition. The processor obtains an image by using the camera if the vehicle enters a specific point, recognizes information related to the specific point in the image, assigns a weight to the recognized information according to a predetermined criterion, and estimates the location of the vehicle based on the recognized information to which the weight is applied.

### CROSS-REFERENCE TO RELATED APPLICATION

This application claims under 35 U.S.C. § 119 (a) the benefit of Korean Patent Application No. 10-2024-0067220, filed in the Korean Intellectual Property Office on May 23, 2024, the entire contents of which are incorporated herein by reference.

### BACKGROUND

### (a) Technical Field

The present disclosure relates to a vehicle apparatus and a method of estimating a location of a vehicle, more particularly, to the vehicle apparatus and the method configured to estimate the location of the vehicle and/or to construct a map via image recognition.

### (b) Description of the Related Art

A location determination and map construction method using a global positioning system (GPS) and dead reckoning (DR) (GPS/DR) technology determines the location of a vehicle and constructs a map by using satellite data, a gyro sensor, and an acceleration sensor. The location determination estimation and map construction method using the GPS/DR technology includes difficulty in correcting accuracy due to the limitations of GPS/DR. If real-time kinematic (RTK) correction is performed, the GPS includes an accuracy of several tens of centimeters under the open sky, but includes limitations due to the cost burden of using RTK and the open sky. The DR was developed greatly while using the recent 6-axis sensor instead of the existing 3-axis sensor. However, due to the accumulation of errors, the DR includes errors of several meters.

In a state where there are errors, the accuracy of map construction also decreases. To minimize the error, separate GPS coordinates may be measured by another device at the start time point of map construction, or the error may be minimized via DR calibration. However, the accuracy is bound to decrease in a place such as an underground parking lot or an urban canyon.

Moreover, nowadays, methods are used to estimate the location of a host vehicle or to construct a map by using image recognition. However, to estimate the location by using image recognition, a separate reference point or reference map is required, and thus there are limitations in estimating the location and constructing the map. Relative locations of objects, which are recognized by using image recognition, from the host vehicle may be specified. However, the location or map location of the host vehicle, which is a standard, is required to estimate absolute coordinates in the real world.

Furthermore, if image recognition is used, image recognition performance deteriorates in environments with performance limitations, such as vehicle terminals. In addition, if information is sent to a server for high-performance image recognition, data costs may continuously incur.

### SUMMARY

An aspect of the present disclosure provides a vehicle apparatus that estimates a location of a vehicle and constructs a map via image recognition, and a location estimation and map construction method thereof.

Moreover, an aspect of the present disclosure provides a vehicle apparatus that specifies a reference point or a recognition target if a location of a vehicle is estimated and a map is constructed via image recognition, and a location estimation and map construction method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle apparatus includes a camera and a processor. The processor obtains an image by using the camera if a vehicle enters a specific point, recognizes information related to the specific point in the image, assigns a weight to the recognized information according to a predetermined criterion, and estimates a vehicle location based on the recognized information to which the weight is applied.

The processor determines that the vehicle enters the specific point, if a vehicle location measured by a vehicle sensor is finally matched to an entry link of the specific point on map data stored in a memory.

The processor recognizes an object in the image obtained by the camera and determines that the vehicle enters the specific point, based on the recognized object.

The processor receives a signal received from communication equipment installed at the specific point via a communication device, and determines that the vehicle enters the specific point, based on identification information of the specific point included in the received signal.

The processor determines that the vehicle enters the specific point, based on an altitude measured by a vehicle sensor, if the vehicle is placed on an offroad.

The processor extracts information related to the specific point from the image by using an image recognition model mapped for the respective specific point.

The processor determines a weight for the recognized information based on a relevance degree between the recognized information and the specific point.

The processor transmits the image to a server and makes a request for image recognition if mapping failure between the recognized information and map data is repeated a predetermined number of times or more.

The processor crops only a region of interest (ROI) of the specific point from the image and transmits the ROI to the server.

The processor configures map data by matching the recognized information based on coordinates.

A vehicle includes the above-described vehicle apparatus.

According to an aspect of the present disclosure, a method of estimating a location of a vehicle includes: obtaining, by a processor, an image by using a camera if a vehicle enters a specific point; recognizing, by the processor, information related to the specific point in the image; assigning, by the processor, a weight to the recognized information according to a predetermined criterion; and estimating, by the processor, a vehicle location based on the recognized information to which the weight is applied.

The obtaining of the image includes determining that the vehicle enters the specific point, if a vehicle location measured by a vehicle sensor is finally matched to an entry link of the specific point on map data stored in a memory.

The obtaining of the image includes recognizing an object in the image obtained by the camera, and determining that the vehicle enters the specific point, based on the recognized object.

The obtaining of the image includes receiving a signal received from communication equipment installed at the specific point via a communication device, and determining that the vehicle enters the specific point, based on identification information of the specific point included in the received signal.

The obtaining of the image includes determining that the vehicle enters the specific point, based on an altitude measured by a vehicle sensor, if the vehicle is placed on an offroad.

The recognizing of the information includes extracting information related to the specific point from the image by using an image recognition model mapped for the respective specific point.

The assigning of the weight includes determining a weight for the recognized information based on a relevance degree between the recognized information and the specific point.

The method further includes transmitting the image to a server and making a request for image recognition if mapping failure between the recognized information and map data is repeated a predetermined number of times or more.

The making of the request for the image recognition includes cropping only an ROI of the specific point from the image and transmitting the ROI to the server.

According to an aspect of the present disclosure, a method of constructing a map includes: obtaining, by a processor, an image by using a camera if a vehicle enters a specific point; recognizing, by the processor, information related to the specific point in the image; and configuring, by the processor, map data by matching the recognized information based on coordinates.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a vehicle apparatus, according to embodiments of the present disclosure;

FIG. 2 is a flowchart illustrating a location estimation and map construction method of a vehicle apparatus, according to embodiments of the present disclosure;

FIG. 3 is a flowchart showing a vehicle location estimation process, according to an embodiment of the present disclosure;

FIG. 4 is a flowchart showing a vehicle location estimation process, according to another embodiment of the present disclosure;

FIG. 5 is a flowchart showing a map construction process, according to embodiments of the present disclosure; and

FIG. 6 is a block diagram showing a computing system related to a vehicle apparatus and a location estimation and map construction method thereof, according to embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted if they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

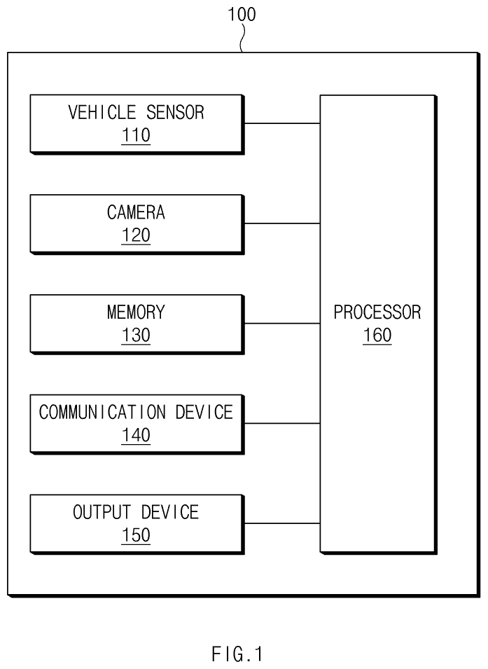

FIG. 1 is a block diagram showing a vehicle apparatus, according to embodiments of the present disclosure.

Referring to FIG. 1, a vehicle apparatus 100 may include a vehicle sensor 110, a camera 120, a memory 130, a communication device 140, an output device 150, and a processor 160.

The vehicle sensor 110 may obtain sensor data by using at least one of sensors mounted on a vehicle such as a GPS, an acceleration sensor, a gyro sensor, an inertial measurement unit (IMU), and/or a wheel speed sensor. The sensor data may include the vehicle's location information (e.g., absolute coordinates), acceleration, angular velocity, and/or wheel speed.

The camera 120 may capture external images of the vehicle. The camera 120 may store the captured images in the memory 130 and/or a memory (not shown) mounted on the camera 120. The camera 120 may directly transmit the captured images to the processor 160.

The camera 120 may be implemented with at least one image sensor among image sensors such as a charge coupled device (CCD) image sensor image sensor, a complementary metal oxide semi-conductor (CMOS) image sensor, a charge priming device (CPD) image sensor, a charge injection device (CID) image sensor, and the like. The camera 120 may include an image processor that performs image processing such as noise cancellation, color reproduction, file compression, image quality adjustment, and saturation adjustment on the images obtained via the image sensor.

The memory 130 may store sensor data obtained by the vehicle sensor 110 and/or images captured by the camera 120. The memory 130 may store an image recognition model (or a recognition model) executed by the processor 160. The image recognition model may be logic or a machine learning model that detects a desired object based on a video (or image). The memory 130 may store object information detected by the image recognition model. The memory 130 may store map data.

The memory 130 may be a non-transitory storage medium that stores instructions executed by the processor 160. The memory 130 may be implemented with at least one of storage media (recording media) such as a flash memory, a hard disk, a solid state disk (SSD), a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), and/or web storage. The communication device 140 may support wireless or wired communication between the vehicle apparatus 100 and an external electronic device (e.g., a server, etc.). The communication device 140 may use wireless communication technologies such as wireless Internet (e.g., Wi-Fi), short-range communication (e.g., Bluetooth, ZigBee, and infrared communication), and mobile communication, wired communication technologies such as local area network (LAN), wide area network (WAN), Ethernet, and/or integrated services digital network (ISDN), and/or vehicle-to-everything (V2X) technologies, such as vehicle-to-vehicle communication (V2V), vehicle-to-infrastructure (V2I), and/or in-vehicle network (IVN). The communication device 140 may include a communication processor, a communication circuit, an antenna, and/or a transceiver.

The output device 150 may output progress situations and/or processing results according to the operation of the processor 160 as information such as visual information, auditory information, and/or tactile information. The output device 150 may include a display (e.g., a touch screen, a head-up display (HUD), and/or a liquid crystal display (LCD)), a speaker, and/or a vibrator.

The processor 160 may control overall operations of the vehicle apparatus 100. The processor 160 may be implemented with at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

The processor 160 may determine a vehicle location on the map by mapping the vehicle location measured by GPS onto map data stored in the memory 130.

The processor 160 may determine whether a vehicle arrived at a specific point, based on information capable of specifying a point. The processor 160 may obtain the information capable of specifying a point by using at least one of the vehicle sensor 110, the camera 120, or the communication device 140, or any combination thereof. The Information capable of specifying a point may include at least one of map information (map data), image information, communication information, or vehicle location information (e.g., including absolute coordinates, altitude, or the like), or any combination thereof. The specific point may be determined in advance by a system designer. For example, the specific point may be a point of interest (POI) such as a parking lot, a gas station, a department store, or the like.

For example, the processor 160 may match the vehicle location measured via GPS with map data stored in the memory 130. If the vehicle location is finally matched to an entry link of a parking lot, the processor 160 may determine that the vehicle entered (reached) the parking lot.

For another example, if the vehicle enters a parking lot and/or each floor, the processor 160 may obtain images by using the camera 120. The processor 160 may recognize (or detect) an object in the obtained image. The processor 160 may determine that the vehicle arrived at a specific point in the parking lot, based on the recognized object.

For another example, the processor 160 may receive a signal (e.g., a Wi-Fi signal or a beacon signal) transmitted from communication equipment installed in a specific store via the communication device 140. The processor 160 may determine that the vehicle arrived at a specific store, based on store information (e.g., a store identification code) included in the received signal.

For another example, the processor 160 may detect that an altitude value is changed, by using the vehicle sensor 110, after the vehicle enters a place (hereinafter referred to as “offroad”) other than a road. The processor 160 may estimate that the vehicle arrived at the specific point, based on the changed altitude value. For example, if the altitude of a point where the vehicle was located before entering the offroad was 10 m, the altitude of the point where the vehicle was located is changed to 7 m, and the vehicle stops at the corresponding location, the processor 160 may determine that the vehicle arrived at the specific point.

If it is determined that the vehicle arrived at the specific point, the processor 160 may perform location estimation of the vehicle by using image recognition.

To this end, if it is determined that the vehicle arrived at the specific point, the processor 160 may obtain images around the vehicle by using the camera 120. The processor 160 may extract information related to the specific point from the image, which is obtained by the camera 120, by using the image recognition model stored in the memory 130. In this case, the processor 160 may use an image recognition model mapped onto a specific point with reference to a lookup table stored in the memory 130. An image recognition model suitable to recognize information related to a specific point may be defined in the lookup table for each specific point.

Moreover, if it is determined that the vehicle is located at the specific point, the processor 160 may recognize information (e.g., an object and/or text) related to the corresponding specific point in the image obtained by the camera 120. In this case, the processor 160 may extract information from an image obtained by using the image recognition model stored in the memory 130. The processor 160 may assign a weight to the recognized information based on a relevance degree between the recognized information and the specific point. For example, the processor 160 may assign a higher weight to the recognized information as the recognized information is more related to the specific point, and may assign a lower weight to the recognized information as the recognized information is less related to the specific point. Furthermore, if the recognized information is information that is not related to the specific point, the processor 160 may assign a low weight to the recognized information or may filter and exclude the recognized information.

For example, if information recognized in the image obtained by the camera 120 matches map data of the specific point, the processor 160 may assign a weight to the recognized information.

For another example, if the vehicle is parked in a parking lot, the processor 160 may use a specialized model to recognize information related to the parking lot or may assign a weight to information related to the parking lot. The processor 160 may recognize text indicating a floor or a parking area in the parking lot and/or a sign for guiding an elevator location from the image, which is obtained by the camera 120, as parking lot-related information by using the specialized model. Furthermore, the processor 160 may assign a weight to the parking lot-related information recognized in the image obtained by the camera 120 based on a predetermined criterion.

For another example, if the vehicle enters POI, the processor 160 may use a model specialized to recognize information (e.g., an entrance sign and/or POI name) related to a POI category or may assign a weight to the information related to the POI category based on the predetermined criterion. The processor 160 may recognize the information related to the POI category in the image, which is obtained by the camera 120, by using the specialized model. Moreover, the processor 160 may assign a weight to the information related to the POI category recognized in the image obtained by the camera 120.

For another example, if the vehicle is parked in a parking lot, the processor 160 may extract information from the image obtained by the camera 120. The processor 160 may select information unrelated to the parking lot from the extracted information. The processor 160 may assign a low weight to the selected information unrelated to the parking lot or may filter and exclude the corresponding information.

For another example, the processor 160 may recognize information, which is present at a predetermined specific location, depending on the characteristics of the specific point during image recognition. For example, the processor 160 may recognize only the text placed on a pillar and/or ceiling sign in the parking lot. The processor 160 may assign a weight to the recognized information depending on the predetermined criterion.

For another example, the processor 160 may assign a weight based on at least one of the number of times that the same information is recognized if a weight is assigned to the recognized information, a data size of the recognized information, or confidence of the recognized information, or any combination thereof.

In another embodiment, to obtain accurate image recognition information, the processor 160 may transmit the image obtained by the camera 120 to an external server (not shown) via the communication device 140 and may request image recognition. In this case, the processor 160 may determine whether to transmit the obtained image to the server, based on the predetermined criterion. The server (not shown) may recognize information related to a specific point in the received image and may transmit image recognition information to the vehicle apparatus 100. The processor 160 may receive image recognition information transmitted from a server (not shown).

If transmitting the obtained image to the server, the processor 160 may determine an image upload period based on the characteristics of the specific point and/or vehicle speed. In addition, the processor 160 may upload (transmit) at least part of the obtained image to the server. The processor 160 may crop and upload only the portion, in which the ROI of a specific point is present, from the obtained image. For example, in the case of a parking lot, the processor 160 may crop a text portion, in which the pillar is present, from the obtained image and may upload the text portion to the server. In this way, data efficiency may be maximized while image recognition accuracy is improved.

If information that is not present in the map data is recognized repeatedly a predetermined number of times or more, the processor 160 may also upload an image, which is obtained by the camera 120, to the server. In other words, if mapping failure between the recognized information and map data is repeated a predetermined number of times or more, the processor 160 may transmit the image to the server and may make a request for image recognition to the server. In this case, the server may extract information from the image received from the processor 160. If the extracted information is information corresponding to a specific point and/or a POI characteristic, the server may assign a weight.

In still another embodiment, the processor 160 may construct map data by using information recognized via the image recognition. For example, if constructing map data in the parking lot, the processor 160 may construct the map data within the parking lot by using at least one of a floor, a pillar number, text, coordinates, or an altitude, or any combination thereof based on the obtained recognition information.

Moreover, the processor 160 may configure the map data by matching at least one of pieces of recognized information based on coordinates. Here, the coordinates may be relative coordinates from a specific point or a horizontal coordinate system. In addition, the processor 160 may configure a height (altitude) differently depending on recognized information (e.g., text) even within the same layer.

The processor 160 may estimate (determine) a location of the vehicle based on information recognized via the image recognition. In other words, the processor 160 may determine a value indicating the characteristics (e.g., floor information, parking area information, or the like) of a specific point as a location of the vehicle based on information obtained via the image recognition. For example, if the vehicle is parked in a parking lot, the processor 160 may determine that the location of the vehicle is a “second basement level in the parking lot”, if the information obtained via the image recognition includes text indicating “the second basement level”.

The processor 160 may determine whether the recognized information is related to a current location of the vehicle or whether the recognized information is information about another location. For example, if the recognized information and information about other directions (e.g., an arrow direction and/or an exit direction), the processor 160 may determine the information about other directions as information unrelated to the current location of the vehicle.

If a plurality of objects are recognized via the image recognition, the processor 160 may match the plurality of objects with the absolute coordinates of map data. In this case, if at least part of the plurality of objects matches the map data, the processor 160 may estimate a location (a current location) of the vehicle by using a location estimation method such as triangulation.

Furthermore, the processor 160 may estimate the location of the vehicle by using the map data constructed via the image recognition.

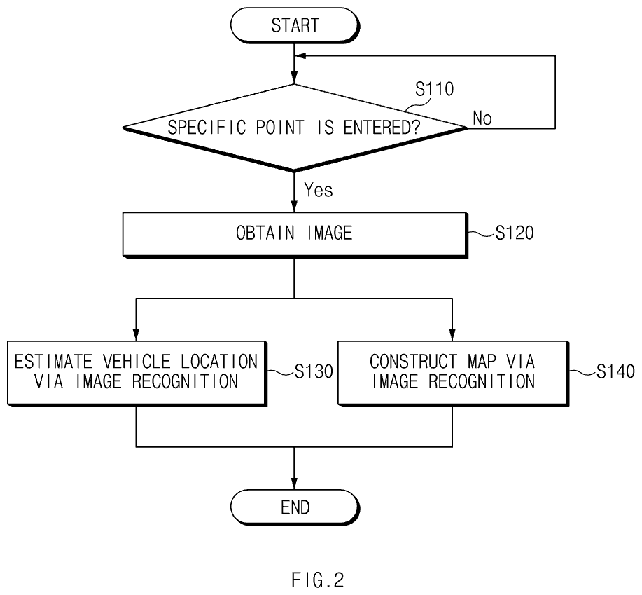

FIG. 2 is a flowchart illustrating a location estimation and map construction method of a vehicle apparatus, according to embodiments of the present disclosure.

The processor 160 of the vehicle apparatus 100 may determine whether a vehicle entered a predetermined specific point (S110). The processor 160 may obtain information capable of specifying a point by using at least one of the vehicle sensor 110, the camera 120, or the communication device 140, or any combination thereof. The Information capable of specifying a point may include at least one of map information (map data), image information, communication information, or vehicle location information (e.g., including absolute coordinates, altitude, or the like), or any combination thereof. The specific point may be determined in advance by a system designer. For example, the specific point may be a point of interest (POI) such as a parking lot, a gas station, a department store, or the like.

For example, the processor 160 may map a vehicle location obtained by the vehicle sensor 110 to map data stored in the memory 130. The processor 160 may determine whether the vehicle entered the specific point, based on the mapping result. In other words, the processor 160 may determine that the vehicle entered the specific point, if the vehicle location obtained by the vehicle sensor 110 is finally mapped to an entry link of the specific point.

For another example, if the vehicle enters a parking lot and/or each floor, the processor 160 may obtain images by using the camera 120. The processor 160 may recognize (or detect) an object in the obtained image. The processor 160 may determine that the vehicle arrived at a specific point in the parking lot, based on the recognized object.

For another example, the processor 160 may receive a signal (e.g., a Wi-Fi signal or a beacon signal) transmitted from communication equipment installed in a specific place via the communication device 140. The processor 160 may determine that the vehicle arrived at the specific point, based on identification information (e.g., a store identification code) of the specific point included in the received signal.

For another example, the processor 160 may detect that an altitude value is changed, by using the vehicle sensor 110, after the vehicle enters an offroad. The processor 160 may estimate that the vehicle arrived at the specific point, based on the changed altitude value. For example, if the altitude of a point where the vehicle was located before entering the offroad was 10 m, the altitude of the point where the vehicle was located is changed to 7 m, and the vehicle stops at the corresponding location, the processor 160 may determine that the vehicle arrived at the specific point.

If it is determined that the vehicle entered the specific point, the processor 160 may obtain an image by using the camera 120 (S120). The camera 120 may obtain an image around the vehicle and may transmit the image to the processor 160. The camera 120 may store the obtained image in the memory 130.

The processor 160 may estimate the vehicle location via the image recognition (S130). The processor 160 may extract information related to the specific point from the image, which is obtained by the camera 120, by using the image recognition model stored in the memory 130. In this case, the processor 160 may use an image recognition model mapped onto a specific point with reference to a lookup table stored in the memory 130. An image recognition model suitable to recognize information related to a specific point may be defined in the lookup table for each specific point. The processor 160 may estimate the location of the vehicle based on the extracted information.

The processor 160 may construct map data via the image recognition (S140). The processor 160 may extract information related to the specific point from the image, which is obtained by the camera 120. The processor 160 may generate map data based on the extracted information.

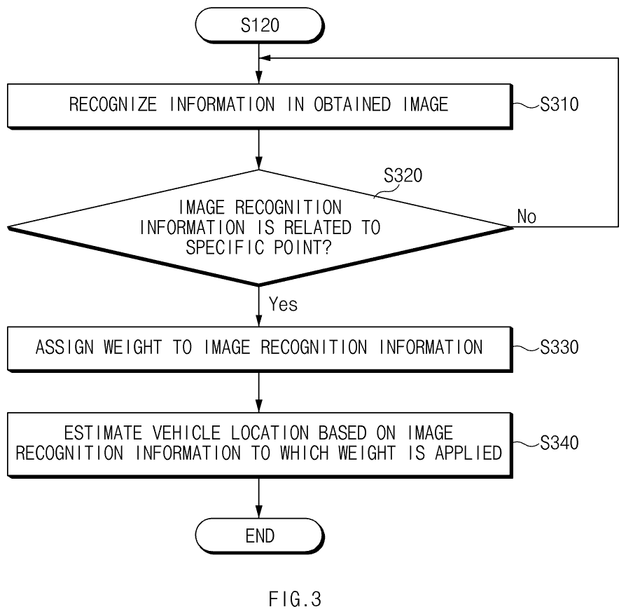

FIG. 3 is a flowchart showing a vehicle location estimation process, according to an embodiment of the present disclosure.

Referring to FIG. 3, the processor 160 of the vehicle apparatus 100 may recognize information in an image obtained by the camera 120 (S310). The processor 160 may extract information (e.g., an object, text, or the like) from the obtained image by using an image recognition model stored in the memory 130.

The processor 160 may determine whether information (hereinafter referred to as “image recognition information”) recognized in the image is related to a specific point (S320). The processor 160 may evaluate the degree (or a relevance degree), to which the image recognition information is related to the specific point, by applying a well-known relevance degree evaluation method. The processor 160 may determine whether the image recognition information is related to the specific point, based on the relevance degree to the specific point. In other words, if the relevance degree to the specific point exceeds a predetermined reference value, the processor 160 may determine that image recognition information is related to the specific point. In the meantime, if the relevance degree to the specific point is smaller than or equal to the predetermined reference value, the processor 160 may determine that image recognition information is not related to the specific point.

If the image recognition information is related to a predetermined point, the processor 160 may assign a weight to the corresponding image recognition information (S330). If it is determined that the vehicle is located at the specific point, the processor 160 may recognize information (e.g., an object and/or text) related to the corresponding specific point in the image obtained by the camera 120. In this case, the processor 160 may extract information from an image obtained by using the image recognition model stored in the memory 130. The processor 160 may assign a weight to the recognized information based on a relevance degree between the recognized information and the specific point. For example, the processor 160 may assign a higher weight to the recognized information as the recognized information is more related to the specific point, and may assign a lower weight to the recognized information as the recognized information is less related to the specific point. Furthermore, if the recognized information is information that is not related to the specific point, the processor 160 may assign a low weight to the recognized information or may filter and exclude the recognized information.

For example, if information recognized in the image obtained by the camera 120 matches map data of the specific point, the processor 160 may assign a weight to the recognized information.

For another example, if the vehicle is parked in a parking lot, the processor 160 may use a specialized model to recognize information related to the parking lot or may assign a weight to information related to the parking lot. The processor 160 may recognize text indicating a floor or a parking area in the parking lot and/or a sign for guiding an elevator location from the image, which is obtained by the camera 120, as parking lot-related information by using the specialized model. Furthermore, the processor 160 may assign a weight to the parking lot-related information recognized in the image obtained by the camera 120 based on a predetermined criterion.

For another example, if the vehicle enters POI, the processor 160 may use a model specialized to recognize information (e.g., an entrance sign and/or POI name) related to a POI category or may assign a weight to the information related to the POI category based on the predetermined criterion. The processor 160 may recognize the information related to the POI category in the image, which is obtained by the camera 120, by using the specialized model. Moreover, the processor 160 may assign a weight to the information related to the POI category recognized in the image obtained by the camera 120.

For another example, if the vehicle is parked in a parking lot, the processor 160 may extract information from the image obtained by the camera 120. The processor 160 may select information unrelated to the parking lot from the extracted information. The processor 160 may assign a low weight to the selected information unrelated to the parking lot or may filter and exclude the corresponding information.

For another example, the processor 160 may recognize information, which is present at a predetermined specific location, depending on the characteristics of the specific point during image recognition. For example, the processor 160 may recognize only the text placed on a pillar and/or ceiling sign in the parking lot. The processor 160 may assign a weight to the recognized information depending on the predetermined criterion.

For another example, the processor 160 may assign a weight based on at least one of the number of times that the same information is recognized if a weight is assigned to the recognized information, a data size of the recognized information, or confidence of the recognized information, or any combination thereof.

The processor 160 may estimate a vehicle location based on the image recognition information to which the weight is applied (S340).

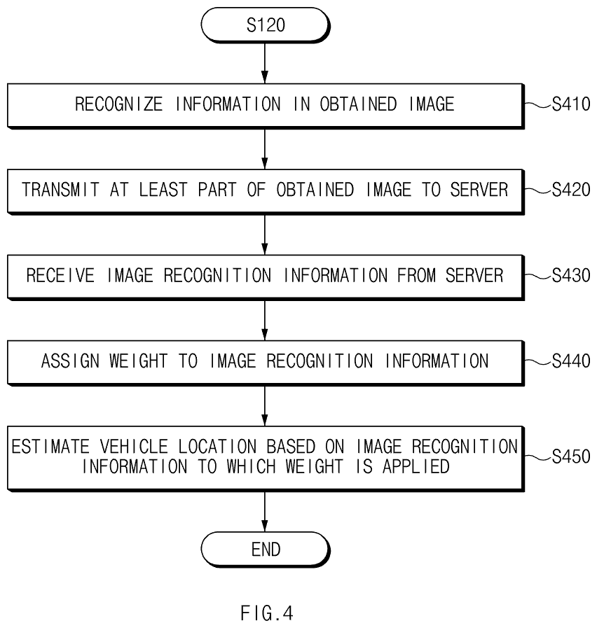

FIG. 4 is a flowchart showing a vehicle location estimation process, according to another embodiment of the present disclosure

Referring to FIG. 4, the processor 160 of the vehicle apparatus 100 may recognize information in an image obtained by the camera 120 (S410). The processor 160 may extract information (e.g., an object, text, or the like) from the obtained image by using an image recognition model stored in the memory 130.

The processor 160 may transmit at least part of the obtained image to a server (S420). If information that is not present in map data is repeatedly recognized a predetermined number of times or more, the processor 160 may transmit the obtained image to the server and may make a request for image recognition to the server. In this case, if the information is information corresponding to a specific point or POI characteristics, the processor 160 may assign a weight. The processor 160 may crop and upload only the portion, in which the ROI of a specific point is present, from the obtained image. For example, in the case of a parking lot, the processor 160 may crop a text portion, in which the pillar is present, from the obtained image and may upload the text portion to the server. In this way, data efficiency may be maximized while image recognition accuracy is improved. If transmitting the obtained image to the server, the processor 160 may determine an image transmission period (or an image upload period) based on the characteristics of the specific point and/or a vehicle speed.

The processor 160 may receive image recognition information received from the server (S430). The server may recognize information related to the specific location from an image received from the vehicle apparatus 100. The server may transmit the recognized information (i.e., image recognition information) to the vehicle apparatus 100.

The processor 160 may assign a weight to the received image recognition information based on a predetermined criterion (S440).

The processor 160 may estimate a vehicle location based on the image recognition information to which the weight is applied (S450).

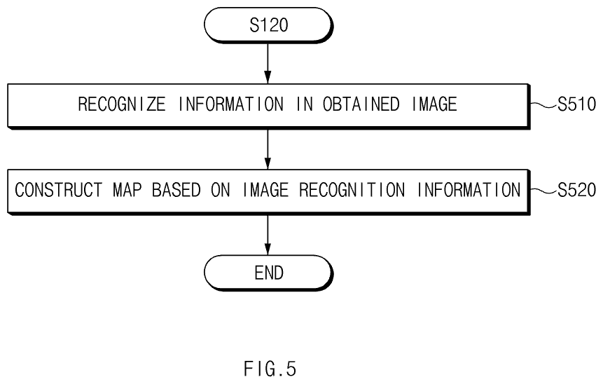

FIG. 5 is a flowchart showing a map construction process, according to embodiments of the present disclosure.

Referring to FIG. 5, the processor 160 may recognize information in an image obtained by the camera 120 (S510).

The processor 160 may construct a map based on information (hereinafter referred to as “image recognition information”) recognized in the image (S520). The processor 160 may generate map data within a parking lot by using at least one of a floor, a pillar number, text, coordinates, or an altitude, or any combination thereof based on the obtained recognition information. Moreover, the processor 160 may configure the map data by matching at least one of pieces of recognized information based on coordinates. Here, the coordinates may be relative coordinates from a specific point or a horizontal coordinate system. In addition, the processor 160 may configure a height (altitude) differently depending on recognized information (e.g., text) even within the same layer.

Afterwards, the processor 160 may store the map data constructed (or generated) via image recognition in the memory 130. Furthermore, the processor 160 may estimate the location of the vehicle by using the map data constructed via the image recognition.

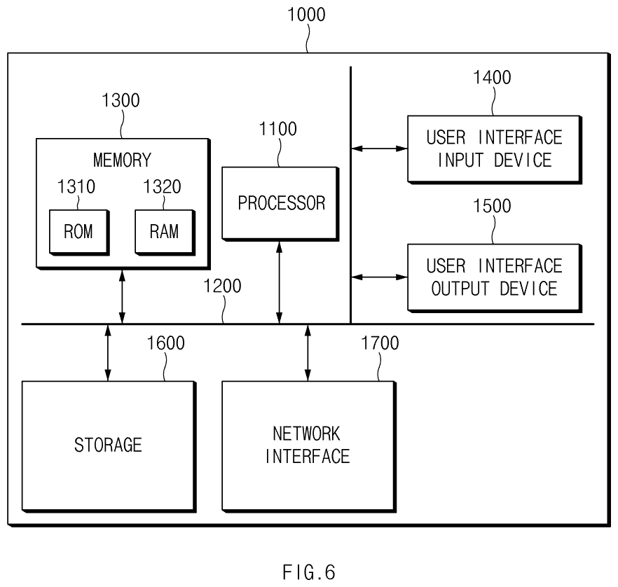

FIG. 6 is a block diagram showing a computing system related to a vehicle apparatus and a location estimation and map construction method thereof, according to embodiments of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor 1100 and storage medium may be implemented with an application specific integrated circuit (ASIC). The ASIC may be provided in a user terminal. Alternatively, the processor 1100 and storage medium may be implemented with separate components in the user terminal.

The above description is merely an example of the technical idea of the present disclosure, and various modifications and variations may be made by one skilled in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

The present disclosure may estimate the location of a vehicle based on information obtained via image recognition in a GPS shadow area, thereby improving location estimation accuracy.

Moreover, the present disclosure may specify a reference point or a recognition target if a vehicle location is estimated and a map is constructed via image recognition, thereby improving the accuracy of image recognition results.

Furthermore, the present disclosure may adjust an image upload period if an image is recognized by using a server, may crop a region of interest (ROI) based on the characteristics of specific points from the image, and may transmit it to the server, thereby increasing image recognition accuracy and maximizing data efficiency.

Besides, the present disclosure may estimate the location of a vehicle based on general location information even though there is no separate map data.

In addition, the present disclosure may estimate the location of a vehicle by using a plurality of objects recognized in the image.

Hereinabove, although the present disclosure was described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle apparatus of a vehicle, the vehicle apparatus comprising:
a camera; and
a processor,
wherein the processor is configured to:
obtain an image by using the camera if the vehicle enters a specific point;
recognize information related to the specific point in the image;
assign a weight to the recognized information according to a predetermined criterion; and
estimate a location of the vehicle based on the recognized information to which the weight is applied.

2. The vehicle apparatus of claim 1, wherein the processor is configured to:
determine that the vehicle enters the specific point, if the location measured by a vehicle sensor is finally matched to an entry link of the specific point on map data stored in a memory.

3. The vehicle apparatus of claim 1, wherein the processor is configured to:
recognize an object in the image obtained by the camera; and
determine that the vehicle enters the specific point, based on the recognized object.

4. The vehicle apparatus of claim 1, wherein the processor is configured to:
receive a signal received from communication equipment installed at the specific point via a communication device; and
determine that the vehicle enters the specific point, based on identification information of the specific point included in the received signal.

5. The vehicle apparatus of claim 1, wherein the processor is configured to:
determine that the vehicle enters the specific point, based on an altitude measured by a vehicle sensor, if the vehicle is placed on an offroad.

6. The vehicle apparatus of claim 1, wherein the processor is configured to:
extract information related to the specific point from the image by using an image recognition model mapped for the respective specific point.

7. The vehicle apparatus of claim 1, wherein the processor is configured to:
determine a weight for the recognized information based on a relevance degree between the recognized information and the specific point.

8. The vehicle apparatus of claim 1, wherein the processor is configured to:
transmit the image to a server and make a request for image recognition if mapping failure between the recognized information and map data is repeated a predetermined number of times or more; and
crop only a region of interest (ROI) of the specific point from the image and transmit the ROI to the server.

9. The vehicle apparatus of claim 1, wherein the processor is configured to:
configure map data by matching the recognized information based on coordinates.

10. A vehicle comprising the vehicle apparatus of claim 1.

11. A method of estimating a location of a vehicle, the method comprising:
obtaining, by a processor, an image by using a camera if the vehicle enters a specific point;
recognizing, by the processor, information related to the specific point in the image;
assigning, by the processor, a weight to the recognized information according to a predetermined criterion; and
estimating, by the processor, a location of the vehicle based on the recognized information to which the weight is applied.

12. The method of claim 11, wherein obtaining the image includes:
determining that the vehicle enters the specific point, if the location of the vehicle measured by a vehicle sensor is finally matched to an entry link of the specific point on map data stored in a memory.

13. The method of claim 11, wherein obtaining the image includes:
recognizing an object in the image obtained by the camera; and
determining that the vehicle enters the specific point, based on the recognized object.

14. The method of claim 11, wherein obtaining the image includes:
receiving a signal received from communication equipment installed at the specific point via a communication device; and
determining that the vehicle enters the specific point, based on identification information of the specific point included in the received signal.

15. The method of claim 11, wherein obtaining the image includes:
determining that the vehicle enters the specific point, based on an altitude measured by a vehicle sensor, if the vehicle is placed on an offroad.

16. The method of claim 11, wherein recognizing the information includes:
extracting information related to the specific point from the image by using an image recognition model mapped for the respective specific point.

17. The method of claim 11, wherein assigning the weight includes:
determining a weight for the recognized information based on a relevance degree between the recognized information and the specific point.

18. The method of claim 11, further comprising:
transmitting the image to a server and making a request for image recognition if mapping failure between the recognized information and map data is repeated a predetermined number of times or more.

19. The method of claim 18, wherein making the request for the image recognition includes:
cropping only an ROI of the specific point from the image and transmitting the ROI to the server.

20. A method of constructing a map, the method comprising:
obtaining, by a processor, an image by using a camera if a vehicle enters a specific point;
recognizing, by the processor, information related to the specific point in the image; and
configuring, by the processor, map data by matching the recognized information based on coordinates.
